(19) United States
(12) Patent Application Publication
(10) Pub. No.: US 2026/0350607 A1
(43) Pub. Date: Nov. 5, 2026

(54) TRANSACTION VALIDATION OPTIMIZATION USING GENERATIVE ARTIFICIAL INTELLIGENCE

(71) Applicant: MASTERCARD INTERNATIONAL INCORPORATED, PURCHASE, NY (US)

(72) Inventors: Balamurali BALASUBRAMANIAN, Chennai (IN); Vikas CHANDRA, Pune (IN)

(21) Appl. No.: 19/196,459

(22) Filed: May 1, 2025

(51) Int. Cl. G06Q 20/40; G06N 20/00; G06Q 20/34

(52) U.S. Cl. CPC G06Q 20/401; G06N 20/00; G06Q 20/34; G06Q 20/405

(57) ABSTRACT

Examples use a machine learning model to select a first subset of validation rules from a plurality of validation rules. This first subset of validation rules is applied to a first payment card transaction, thereby identifying the first payment card transaction as passing the first subset of validation rules. A second subset of validation rules is then applied to the first payment card transaction, thereby identifying the first payment card transaction as failing the second subset of validation rules, the failure of the second subset of validation rules identifying at least one error code. A message is transmitted to a computing device, the message identifying the first payment card transaction and the error code.

### BACKGROUND

Companies often submit batch files containing authorization and clearing transactions for processing. Before these transactions are applied, a pre-processing step is performed on the transactions to, for example, ensure compliance with network rules and data integrity standards. Transactions that fail validation are rejected and assigned error codes, while valid transactions proceed.

However, in large scale systems, applying validations to millions of transactions adds a significant computational burden to transaction processing.

### SUMMARY

An example validation system provides multiple stages of transaction validation using machine learning models where such models are trained, for particular environmental contexts, to identify an initial subset of validation rules to apply when validating transactions before applying a remaining set of validation rules to those transactions. This multi-stage approach allows the validation system to, for example, identify a subset of rules that identifies the most typical error conditions with transactions from a particular customer or region.

Some examples provide a validation system comprising: at least one processor; and at least one memory comprising computer-readable instructions, the at least one processor, the at least one memory and the computer-readable instructions configured to cause the at least one processor to: receive a first payment card transaction from a submitter device; automatically select a first subset of validation rules from a plurality of validation rules using a machine learning model, the machine learning model being configured to identify the first subset of validation rules; apply the first subset of validation rules to the first payment card transaction, thereby identifying the first payment card transaction as passing the first subset of validation rules without indicating an error with the first payment card transaction; after identifying that the first payment card transaction passes the subset of validation rules, apply a second subset of validation rules to the first payment card transaction, thereby identifying the first payment card transaction as failing the second subset of validation rules, the failure of the second subset of validation rules identifying at least one error code; and transmit a message to the submitter device, the message identifying the first payment card transaction and the at least one error code.

Some examples provide a computer-implemented method of validating payment card transactions, the method comprising: using a machine learning model to select a first subset of validation rules from a plurality of validation rules; applying the first subset of validation rules to a first payment card transaction, thereby identifying the first payment card transaction as passing the first subset of validation rules; applying a second subset of validation rules to the first payment card transaction, thereby identifying the first payment card transaction as failing the second subset of validation rules, the failure of the second subset of validation rules identifying at least one error code; and transmitting a message to a computing device, the message identifying the first payment card transaction and the at least one error code.

Some examples provide a computer storage medium having computer-executable instructions that, upon execution by a processor of a computer, cause the processor to at least: receive a first payment card transaction from a submitter device; automatically select a first subset of validation rules from a plurality of validation rules using a machine learning model, the machine learning model being configured to identify the first subset of validation rules; apply the first subset of validation rules to the first payment card transaction, thereby identifying the first payment card transaction as passing the first subset of validation rules without indicating an error with the first payment card transaction; after identifying that the first payment card transaction passes the subset of validation rules, apply a second subset of validation rules to the first payment card transaction, thereby identifying the first payment card transaction as failing the second subset of validation rules, the failure of the second subset of validation rules identifying at least one error code; and send a response message to the submitter device, the response message including a transaction identifier of the first payment card transaction and an error code identifier of the at least one error code.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is an architecture and data flow diagram for an example validation system that provides computational processing improvements during validation of transactions in a payment network.

FIG. 1B is an architecture and data flow diagram for an example validation system that provides computational processing improvements during validation of transactions in a payment network.

FIG. 2A is a flow chart and data flow diagram that illustrates details regarding model training for an example rules model.

FIG. 2B is a flow chart and data flow diagram that illustrates details regarding model training for an example failure model.

FIG. 3 is a flow chart and data flow diagram that illustrates an example validation process.

FIG. 4 is a flow chart of a method of validating payment card transactions.

FIG. 5 is a functional block diagram of a computing apparatus according to an embodiment.

Corresponding reference characters indicate corresponding parts throughout the drawings. Any of the figures may be combined into a single example or embodiment.

### DETAILED DESCRIPTION

A significant challenge in a transaction validation process is the computational burden associated with applying a large set of integrity rules to each transaction within high-volume batch submissions. Typical validation processing can include applying hundreds or thousands of rules during this process. Conventionally, each transaction is checked against all these rules, for issues such as format verification, duplicate detection, authorization-clearing matching, and merchant/acquirer legitimacy. As transaction volumes scale, particularly in real-time or near-real-time processing environments, these validation checks can introduce processing latency, increase system resource utilization, and create bottlenecks in transaction throughput. Additionally, redundant or sequential rule evaluations lead to inefficiencies, further exacerbating computational load and impacting overall network performance.

In contrast, an example validation system is provided that uses machine learning to optimize the computational performance of the transaction validation process. In examples, the validation system trains machine learning model(s) to identify a subset of rules (the “primary subset”) from a set of validation rules (the “full validation set”) given a particular set of transactions (e.g., the subset of rules that is most likely to identify errors in that set of transactions for a particular customer, region, transaction type, or the like). The validation system thus trains multiple models, where each particular model is trained to output a subset of rules given a particular set of transactions as input, and where each particular model is specifically trained on historical successful and failed validations based on one or more particular filter criteria (e.g., the particular customer, particular region, particular transaction type).

During operation, when the validation system is initially presented with transactions (e.g., a batch file of transactions for authorization, for clearing/settlement, or such), the validation system identifies which particular model to use for this set of transactions (e.g., based on the filter criteria of the trained models as compared to the corresponding attributes of the specific transactions received). After having selected a particular model to use during validation of these transactions, the validation system inputs these transactions to that model (or a subset of fields of those transactions, depending on the transaction features used to train the model), thereby causing the model to output a primary subset of rules to be initially applied to these transactions. The validation system then applies this primary subset of rules to the transactions as a first pass, during a “primary validation” phase.

This primary validation thus causes some transactions to be identified as erroneous (e.g., including one or more error codes for each “failed transaction”), while other transactions may pass the primary validation phase as “clean transactions,” at least at this stage. Accordingly, the validation system generates and transmits a failure report back to the submitting entity, where the failure report identifies each of the particular transactions that failed, as well as the particular error code(s) identified during the primary validation phase. These failed transactions can be addressed and subsequently resubmitted for later evaluation.

For transactions that are clean during the primary validation phase (e.g., no errors identified by the primary subset of rules), those transactions have thus been evaluated against only a subset of the validation rules (e.g., the primary subset). As such, the validation system applies the remaining validation rules to these transactions to during a secondary validation phase. In some examples, these “remaining rules” represents all rules that were not applied during the primary validation phase, in some examples. In other examples, the “remaining rules” represents a subset of rules not applied during the primary validation phase. Those transactions that fail during the secondary validation phase cause the validation system to generate and transmit a failure report identifying those failed transactions and their associated error code(s). For the remaining “clean transaction,” namely those transactions for which there was no error identified during either the primary validation phase or the secondary validation phase, the validation system proceeds to process these transactions (e.g., submitting authorization-type transactions for authorization, submitting clearing-type transactions for settlement, and the like).

The validation system provides a multi-staged approach to the pre-processing and validation of transactions in a payment card network that improves the computational performance of the system by using machine learning models to identify a subset of validation rules to initially apply to a set of transactions, thereby rejecting some transactions due to more common or typical error conditions without having to apply a full set of validation transactions to those failing transactions. In addition to reducing computational demands of the validation process, as compared to traditional systems that apply all validation rules to all transactions, the validation system also reduces processing latency in the payment network by providing a more prompt failure response to the submitting institutions, thereby increasing the response time for resubmission of failed transactions.

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

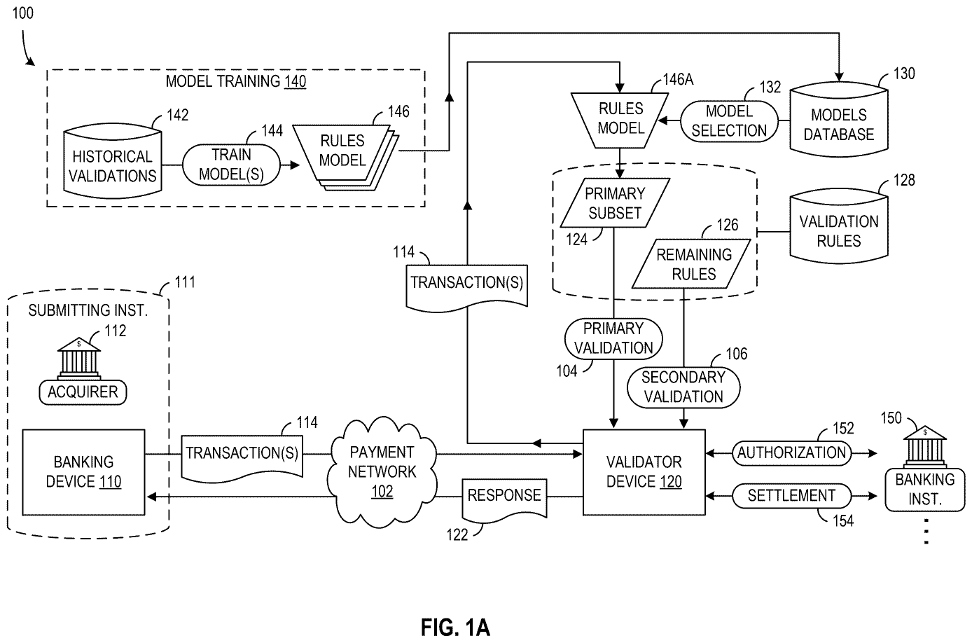

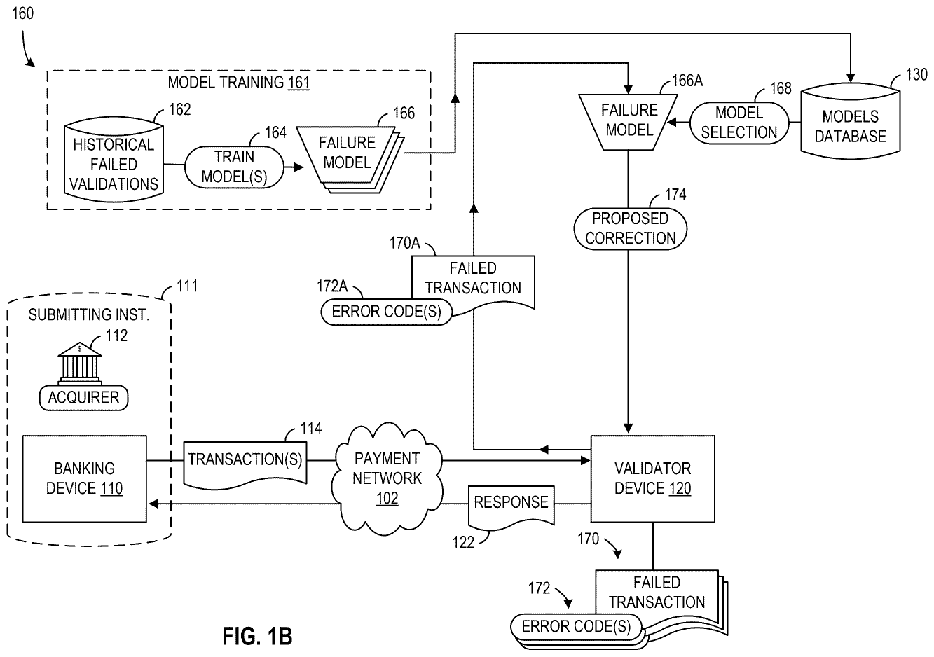

FIG. 1A is an architecture and data flow diagram for an example validation system 100 that provides computational processing improvements during validation of transactions 114 in a payment network 102. In the example, a banking institution (or “submitting institution”) 111, such as an acquiring bank (or “acquirer”) 112, submits one or more transactions 114 to the payment network 102 for processing (e.g., authorization transactions, clearing transactions, settlement requests, and the like). Prior to applying these transactions 114 on the payment network 102, a validator device 120 performs a transaction-level validation process on these transactions 114 (e.g., a pre-processing inspection that is configured to identify error conditions that can cause these transactions to fail). The validator device 120 uses aspects of machine learning to improve the performance of this validation process by breaking up the validation process into two (or more) subprocesses, namely a primary validation subprocess (or just “primary validation”) 104 and a secondary validation subprocess (or just “secondary validation”) 106.

More specifically, in the example, the validator device 120 initially performs a primary validation sub-process (or just “primary validation”) 104 on the transactions 114 that applies only a portion of validation rules 128 to those transactions 114, namely a “primary subset” 124 of those rules 128. Any transactions 114 that ‘fail’ (e.g., cause errors to be generated during the validation process) during primary validation 104 cause a failure report (e.g., as a response 122) to be generated and transmitted back to the submitting device (e.g., banking device 110 of the submitting institution 111), thereby allowing the submitter 111 to correct these errors before resubmitting those particular transactions. Any transactions 114 that ‘pass’ primary validation 104 (e.g., do not fail) are then subjected to the rest of the validation rules 128 (namely, remaining rules 126) during secondary validation 106. As such, since ‘failing’ transactions are only subjected to the primary subset 124 of validation rules 128 (during primary validation 104), the validation system 100 thus reduces computational burden by avoiding applying the entire set of validation rules 128 to those transactions that have the most common errors for that particular customer or region. Additional details regarding this validation system 100 and the validation sub-processes 104, 106 are described below.

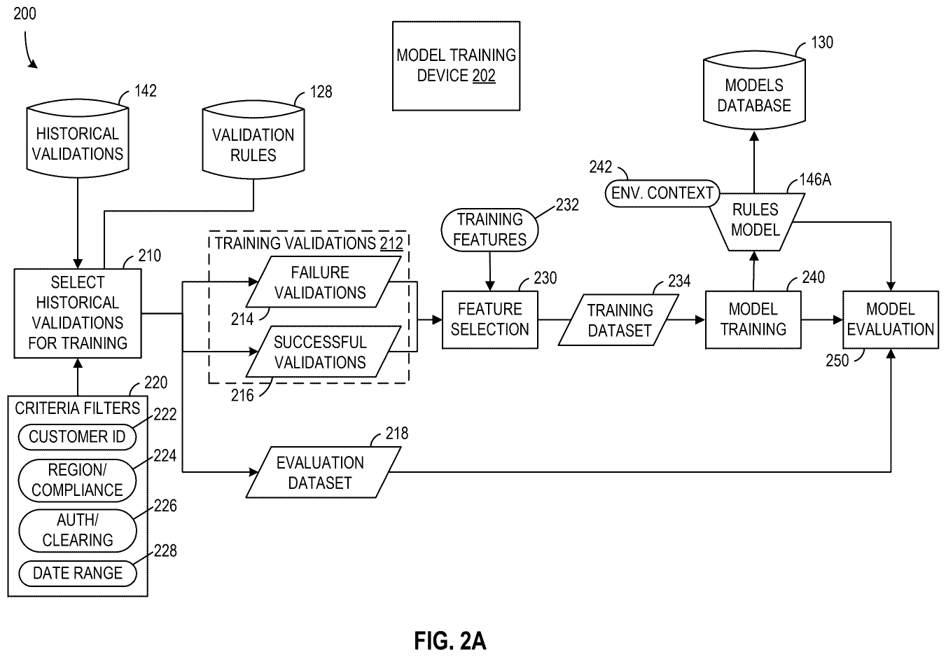

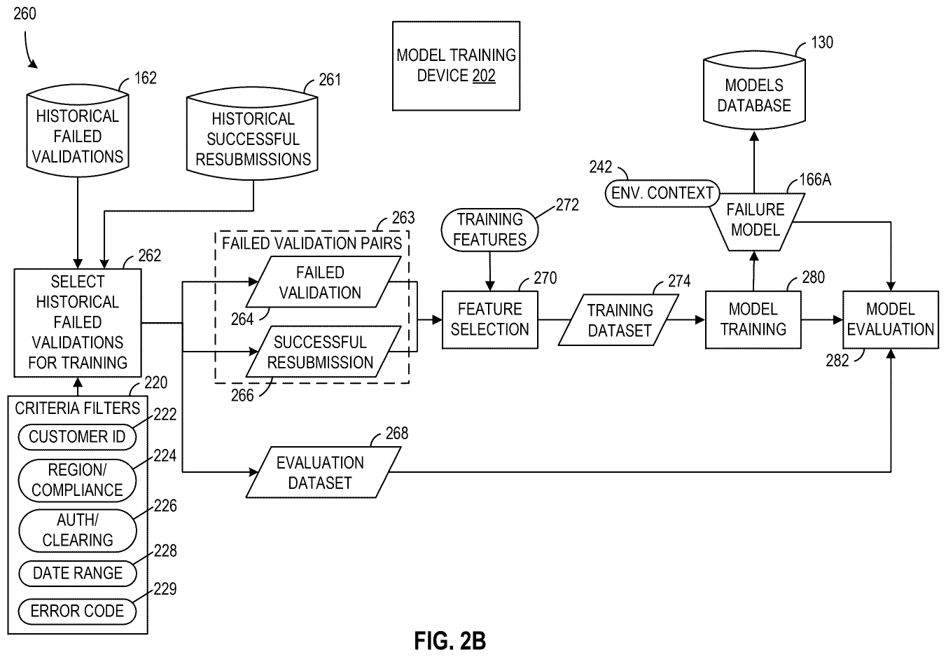

In the example, the validation system 100 performs model training 140 to train one or more rules models 146 that will later be used during the validation process. More specifically, the validation system 100 uses historical validations 142 to train 144 a plurality of rules models 146, where each particular rules model 146 is tailored to specific transaction criteria (not shown in FIG. 1), such as particular customers (e.g., submitting institution 111), particular regions (e.g., regulatory regions, geographic regions, jurisdictions), particular transaction types (e.g., authorization transactions, clearing transactions, settlement transactions), or the like. For any given rules model 146, model training 140 of that model 146 includes identifying particular historical validations 142 that match particular transaction criteria and using those historical validations 142 to train 144 that particular model 146. Each rules model 146 is configured to take, as inputs, a set of transaction features (e.g., particular fields of one or more transactions) and to generate, as outputs, a set of rules (e.g., a primary subset 124 of rules from the validation rules 128) that are most likely to generate errors in those particular transactions. As such, during model training 140, a plurality of rules models 146 are created and stored in a models database 130, where each particular model 146 has an associated set of transaction criteria that is later used to select a particular rules model 146A during the verification process (described in further detail below). This model training 140 is described below in further detail with regard to FIG. 2A.

During the validation process, the validation system 100 uses a particular models 146A to identify the primary subset 124 from the validation rules 128 based on the particular transactions 114 currently being processed. More specifically, in examples, after the validator device 120 receives the transactions 114 from the banking device 110, the validator device 120 uses these transactions 114 to identify a particular rules model 146A from the models database 130 (e.g., based on transaction criteria of those transactions 110, such as the particular submitter 111, a region associated with these transactions, or the like). Accordingly, this model selection 132 causes the particular rules model 146A to be selected from the models database 130 for validation processing of these particular transactions 114.

After selection 132 of the rules model 146A, the validator device 120 applies the set of transactions 114 as inputs to the rules model 146A, thereby causing the rules model 146A to generate the primary subset of rules 124 that will be applied to these transactions 114. The primary subset 124 represents a portion of the validation rules 128, namely a subset 124 of the entire set of validation rules 128 that are most likely to identify errors within these particular transactions 114 (e.g., given the particular details of the submitting institution 111, as well as the particular features of these transactions 114). Since the selected model 146A has been specifically trained on historical validations 142 specific to this submitter 111 (e.g., based on customer, region) and the features that did or did not trigger errors within those historical validations (e.g., based on the validation rules 128 previously identifying historical errors), the selected model 146A is thus trained to identify the particular rules (e.g., primary subset 124) that are most likely to identify errors in these present transactions 114.

During primary validation 104, the validator device 120 applies only the rules from the primary subset 124 to these transactions 114 (e.g., during a “first pass” or “primary validation phase”). This application of the primary subset 124 includes applying each of the rules of the primary subset 124 to each of the transactions 114. More specifically, in examples, each rule from the primary subset 124 is applied to each transaction 114, and each transaction 114 either passes a given rule or causes an error to be identified for that transaction 114 based on that rule. When application of a particular rule identifies an error for a particular transaction 114, that rule includes an error code that is reported back to the submitter 111, thereby allowing the submitter to understand what error was identified for that particular transaction 114.

As such, during primary validation 104 and the associated application of the primary subset 124 to each of the transactions 114, each transaction 114 either passes primary validation 104 successfully (e.g., without generating any errors, “clean”) or fails primary validation 104 in some way (e.g., causing one or more errors to be identified). Accordingly, primary validation 104 has perhaps identified errors in some of the transactions 114 without having to apply all of the validation rules 128 to those particular transactions. The transactions that fail during primary validation 104 are referred to herein as “primary-failed transactions,” and transactions that pass primary validation 104 are referred to herein as “primary-clean transactions.”

In examples, the validator device 120 also performs a secondary validation 106 on all the transactions that passed cleanly through the primary validation 104 (e.g., on all of the primary-clean transactions). More specifically, for the secondary validation 106, the validator device 120 identifies the remaining rules 126 as all of the validation rules 128 that were not included in the primary subset 124. The validator device 120 similarly applies all the rules from the remaining rules 126 to each of the primary-clean transactions. In other words, during secondary validation 106, each of the primary-clean transactions are then subjected to all the remaining rules 126 (e.g., in order to identify any of the less-likely errors that may be generated by these transactions). Similarly, the application of the remaining rules 126 to each of the primary-clean transactions either causes a particular transaction to pass secondary validation 106 successfully (e.g., without generating any errors, “clean”) or fail secondary validation 106 in some way (e.g., causing one or more errors to be identified). The transactions that fail during secondary validation 106 are referred to herein as “secondary-failed transactions” (or, more broadly, just a “failed transaction”, as having failed either the primary validation 104 or the secondary validation 106) and transactions that pass secondary validation 106 are referred to herein as “secondary-clean transactions” (or, more broadly, a “successful transaction” or “clean transaction”, as having passed both the primary validation 104 and the secondary validation 106 without generating any errors).

Accordingly, after having applied the primary subset 124 to all of the transactions 114 during primary validation 104, as well as the remaining rules 126 to the primary-clean transactions, each transaction has either passed successfully without generating any errors (e.g., the secondary-clean transactions), and thus may proceed with processing, or has failed with one or more errors (e.g., primary-failing transactions and secondary-failing transactions, collectively the “failing transactions”). In examples, the validator device 120 identifies the failing transactions and transmits a response report (or just “response”) 122 to the submitter 111, where the response 122 individually identifies each failing transaction (e.g., by transaction identifier, transaction reference details, or the like), one or more error codes identified during the validation process (e.g., indicating the specific validation failure(s)), and perhaps additional details such as error description(s), resolution guidance, or the like. This response 122 allows the submitter 111 to take corrective actions for each of the failed transactions and resubmit (e.g., as another set of transactions 114), which would likewise cause the validator device 120 to re-validate those transactions again via this same validation process.

In the example, for all the clean transactions (e.g., the “secondary-clean transactions”), the validator device 120 submits each of these clean transactions for further processing, either within the payment network 102 or perhaps out to various other parties associated with each of those clean transactions (shown here as banking institution 150, e.g., issuing banks). While this further processing is outside the scope of the novelties of this disclosure, FIG. 1A highlights this further processing as authorization 152 and settlement 154 by way of example. It is presumed that the payment network 102 also transmits a similar response 122 back to the submitter 111 after processing the clean transactions, thereby informing the submitter 111 regarding completion of authorization/clearing/settlement of those clean transactions.

In these examples, a validation of a particular transaction may be referred to herein as “clean”, “successful”, “valid”, or “error-free” when some rule(s) are applied during validation and do not trigger any errors to be identified during that validation (e.g., whether during one of the partial validations 104, 106, or overall). Similarly, a validation of a particular transaction may be referred to herein as “dirty”, “unsuccessful”, “invalid”, “errored”, or “failed” if, when some rule(s) are applied during validation, those rule(s) trigger one or more errors to be identified during that validation. Some example categories of validation rules include syntax checks, format checks, content checks, context checks, business checks, and cross edits.

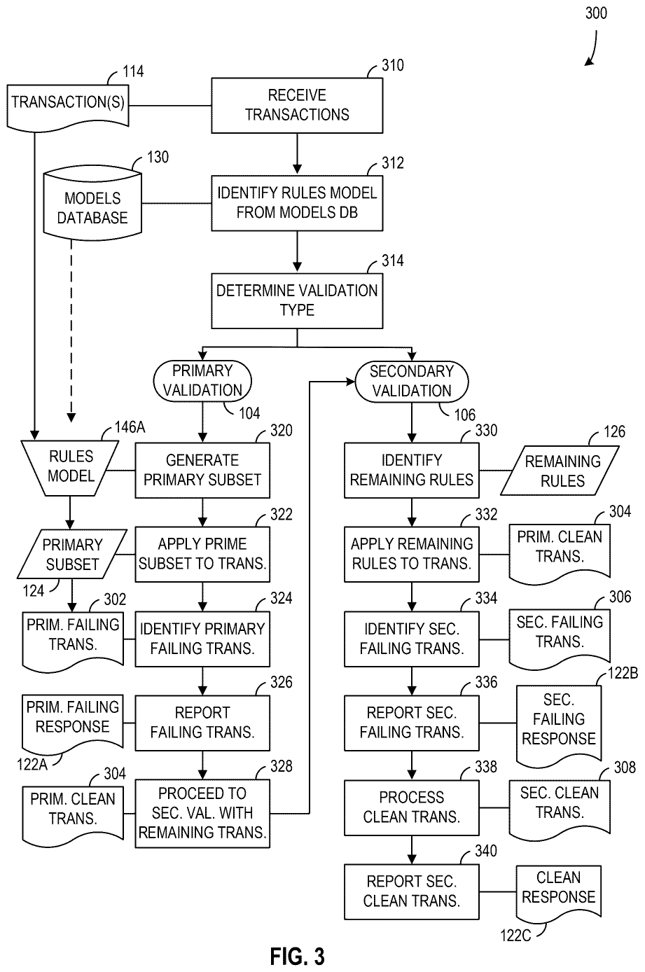

Additional details regarding the training of rules models 146 and the operation of the rules model 146A is described below with respect to FIG. 2A. Additional details regarding the validation process, and particularly the primary validation 104 and secondary validation 106 are described below with respect to FIG. 3.

FIG. 1B is an architecture and data flow diagram for an example validation system 160 that provides computational processing improvements during validation of transactions 114 in a payment network 102. In some examples, the validation system 100 shown in FIG. 1A additionally or alternatively performs the failure analytics described herein in relation to the validation system 160 of FIG. 1B. In the example, it is presumed that a transaction-level validation process has been performed on one or more transactions, such as the transactions 114, and some of these transactions 114 are identified as failed transactions 170. For example, after application of the validation rules 128 shown in FIG. 1A to a particular transaction 114 (e.g., during primary validation 104, during secondary validation 106, or after applying all of the validation rules 128), the validation process generates one or more failure codes 172 for each failed transaction 170. Each particular failure code 172 is identified by the particular validation rule 128 that triggered the failure.

As such, in the example, after validation processing has been performed on the transaction(s) 114, the validator device 120 has identified one or more failed transactions 170 and their associated failure code(s) 172. For each of these failed transactions 170, the validator device 120 uses failure models 166 to perform failure analytics on each of the failed transactions 170. Each of these failure models 166 are configured to analyze a given failed transaction 170A and one or more associated error codes 172A, and to generate one or more proposed corrections 174. Proposed corrections 174 represent recommendations for changes that could be made to the failed transaction 170 in order to “pass” this particular validation failure during resubmission of the associated transaction 114. In examples, such proposed corrections 174 include a field correction (e.g., identifying a particular field code that is missing a value or is otherwise implicated in the validation failure) and a field-value correction (e.g., identifying a particular field code and a particular suggested value for that field). The training and operational application of these failure models 166 are described in greater detail below.

More specifically, in the example, the validation system 160 performs model training 164 to train one or more failure models 166 that will later be used during the validation process. The validation system 160 uses historical failed validations 162 to train 164 a plurality of failure models 166, where each particular failure model 166 is tailored to some specific criteria (not shown in FIG. 1), such as particular customers (e.g., submitting institution 111), particular regions (e.g., regulatory regions, geographic regions, jurisdictions), particular transaction types (e.g., authorization transactions, clearing transactions, settlement transactions), particular failure codes 172, or the like. For any given failure model 166, model training 161 of that model 166 includes identifying particular historical failed validations 162 that match particular transaction and/or failure criteria and using those historical failed validations 162 to train 164 that particular model 166. Each failure model 166 is configured to take, as inputs, a set of transaction features (e.g., particular fields of the failed transaction 170) and one or more failure codes 172, and to generate, as outputs, one or more proposed corrections 174 that may be used to address (e.g., correct) the underlying reasons for failure of that failed transaction 170. As such, during model training 161, a plurality of failure models 166 are created and stored in a models database 130, where each particular model 166 has an associated set of transaction criteria and/or failure codes 172 that is later used to select a particular rules model 166A during the failure analytics process (described in further detail below). This model training 161 is described below in further detail with regard to FIG. 2B.

During the failure analytics process, the validation system 160 uses a particular failure model 166A to generate the proposed correction(s) 174 based on the particular failed transaction 170A and associated failure code(s) 172A currently being analyzed. More specifically, in examples, after the validator device 120 performs the validation process on the transactions 114 (e.g., during primary validation 104, secondary validation 106, and/or application of the validation rules 128 of FIG. 1A) and identifies one or more failed transactions 170 and their associated failure codes 172, the validator device 120 performs failure analytics on each of these failed transactions 170. For each failed transaction 170A and its associated error code(s) 172A, the validator device 120 identifies a particular failure model 166A from the models database 130 (e.g., based on transaction criteria of that failed transaction 170A, such as the particular submitter 111, a region associated with these transactions, the error code(s) 172A, or the like). Accordingly, this model selection 168 causes the particular failure model 166A to be selected from the models database 130 for failure analytics processing of that particular failed transaction 170A.

After selection 168 of the failure model 166A, the validator device 120 applies the failed transaction 170A and error code(s) 172A as inputs to the failure model 166A, thereby causing the failure model 166A to generate one or more proposed corrections 174 for this failed transaction 170A. The proposed correction(s) 174 represent changes that the submitting institution 111 can perform to the underlying transaction 114 when resubmitting that transaction 114. Since the selected model 166A has been specifically trained on historical failed validations 162 specific to this submitter 111 (e.g., based on customer, region) and the features that historically trigger errors within those historical failed validations, the selected model 166A is thus trained to identify the particular proposed corrections 174 that are most likely to help the submitting institution 111 to quickly and successfully correct and resubmit those transactions 114.

In examples, each failed transaction 170 is identified as such in the response 122 and includes the error code(s) 172 identified by the validation process (e.g., during application of the validation rules 128) as well as the proposed correction(s) 174 identified by the failure analytics process. Accordingly, submitting institution 111 is able to consider the failed transactions 170, the error code(s) 172, and the proposed correction(s) 174 prior to resubmitting those failed transactions 170.

FIG. 2A is a flow chart and data flow diagram 200 that illustrates details regarding model training for an example rules model 146A. In some examples, the model training shown in FIG. 2A is similar to the model training 140 of FIG. 1. In the example, a device such as the validator device 120 or a model training device 202 trains the rules model 146A, as well as numerous other rules models 146. Such models 146 are stored in the models database 130, which in some examples is used during the validation process described in FIG. 1A to select a particular model 146A given the particular submitter 111 and transactions 114. It is presumed that each of these rules models 146, once trained, is thus configured to take one or more transactions (e.g., transactions 114) as input and generate an output that identifies one or more validation rules (e.g., the primary subset 124) to be prioritized and evaluated first.

More specifically, in examples, for a particular rules model 146A, the model training device 202 identifies a set of criteria filters 220 to be used for this specific rules model 146A. The criteria filters 220 can include, for example, one or more of a particular customer ID 222 (e.g., identifying the submitting institution 111), a particular region ID 224 (e.g., identifying a particular geographic region, jurisdiction, country, or the like), a transaction type 226 (shown here as “auth/clearing”, e.g., authorization-type transactions, clearing-type transactions), and a date range 228. Criteria filters 220 can include any combination these filters, as well as perhaps multiple filters of each type (e.g., multiple customer IDs 222, multiple regions 224, multiple transaction types 226, multiple date ranges 228).

Criteria filters 220, in the example, represent filters that are used to identify which particular historical validations 142 are used to train a specific model 146A. More specifically, at operation 210, the model training device 202 selects historical validations to be used for training this particular model 146A based on the criteria filters 220 identified for this model 146A (e.g., as selection criteria from historical validations 142). Some such data may be referred to herein as “environmental context,” such as merchant ID, acquirer ID, issuer ID, terminal ID, cardholder number, and/or region, inasmuch as such data may be used as some criteria filters 220 during model training, as well as environmental context 242 associated with a particular rules model 146A that may be present with submitted transactions 114 and used during model selection 132 (e.g., to identify the specific rules model 146A to use for those particular transactions 114).

Each of the historical validations 142, in the example, includes transactions having similar attributes to transactions 114, and that were previously evaluated using the set of validation rules 128, as well as validation data that indicates whether they failed or succeeded during validation, and for those that failed, which validation rules 128 caused the error(s) to be identified during that validation. More specifically, in examples, each historical validation 142 includes (1) transaction data associated with a particular transaction (e.g., fields of data associated with the transaction, such as merchant type, account type, currency code, date/time of the transaction, and many others), as well as (2) validation data associated with the historical validation of that transaction against the validation rules 128 (e.g., validation status of successful or failed, one or more error codes generated during failed validation, one or more rules IDs of validation rules 128 triggered during failed validation). In some examples, the historical validations 142 include data collected during validations of transactions 114 actually performed by the validator device 120 (e.g., during the validation process shown and described in FIG. 1). In some examples, the historical validations 142 include data generated by the model training device 202 after applying all of the validation rules 128 to one or more transactions (e.g., historical transactions performed on the payment network 102, test transactions, or the like). Accordingly, for each historical validation 142, numerous transaction fields are included for a particular transaction (e.g., as identified by the transaction data), as well as whether that particular transaction data succeeded or failed validation in some way (e.g., as identified by the validation data).

In examples, the validation rules 128 include rules that perform mandatory field checks (e.g., ensuring required fields are provided, such as card number, merchant ID, transaction amount, or the like), format and length checks (e.g., validating that fields such as currency codes, dates, and amounts are in the correct format, within acceptable ranges, or the like), card and account status validation (e.g., checking if the payment card is active, not expired, not blocked for fraud, or the like), duplicate transaction check (e.g., ensuring the same transaction is not submitted multiple times), merchant and acquirer validations (e.g., confirming the transaction is submitted by a legitimate merchant, that the acquirer is authorized to process payments), authorization versus clearing matching (e.g., ensuring that a clearing transaction corresponds to a previously approved authorization, such as to prevent mismatches), currency and exchange rate validation (e.g., ensuring the correct currency is used for cross-border transactions, that the exchange rate (if applicable) is within expected limits), or the like.

As such, during the example operation 210, the model training device 202 thus identifies a plurality of historical validations 142 that match the criteria filter(s) 220. Some of these selected validations are successful validations and some of these are failed validations. Accordingly, to train the rules model 146A, the model training device 202 allocates a portion of the selected historical validations for training the model 146A (shown here as training validations 212) and the remainder of the selected historical validations for use as an evaluation dataset 218 (e.g., to evaluate the performance of the model 146A after training). For example, the model training device 202 may select a percentage of the selected validations as training validations 212 (e.g., 60%, 80%, or the like) and the remainder as evaluation dataset 218. This allocation may also include proportional selection of failed validations and successful validations to the training validations 212 and/or the evaluation dataset 218 (e.g., 60% of the failed validations and 60% of the successful validations to the training validations 212 and the remainder of each to the evaluation dataset 218). In FIG. 2A, failure validations 214 and successful validations 216 represent the selected failure and successful validations selected for the training validations 212, and are shown separately for the training validations 212 for purposes of discussion, but it should be understood that the evaluation dataset 218 also includes some of each.

In examples, the transaction data includes fields of data elements associated with the underlying transaction, such as, for example, cardholder information (e.g., primary account number (PAN) or payment token, cardholder name, card expiry date, card verification value (CVV/CVC), cardholder address, phone number, email), transaction details (e.g., transaction date/time, transaction amount, currency code, transaction type, transaction ID, authorization code, response code, approval code, retrieval reference number (RRN), settlement date, transaction status), merchant information (e.g., merchant name, merchant ID (MID), merchant category code (MCC), merchant location, merchant country code, acquirer bank name, acquirer bank identification number (BIN)), terminal and processing information (e.g., point of sale (POS) entry mode, terminal ID (TID), POS condition code, card present indicator, cardholder authentication method, electronic commerce indicator (ECI), tokenization indicator, fraud score), settlement and interchange information (e.g., interchange fee, processing fee, clearing reference number, batch number, chargeback indicator, reversal indicator), enhanced processing data (e.g., invoice number, customer reference ID, loyalty program data, cryptographic signature, tokenized payment data, and level 2/3 data fields such as tax amount, itemized line items, shipping amount, discount amount), or the like.

In examples, the validation data includes a validation status (e.g., success, failure), a failed rules list (e.g., for failed validations, one or more validation rules with which the transaction failed), an error code list (e.g., for failed validations, one or more error codes identified by the failed validation rules), and may include one or more of a rule priority value for each rule in the failed rules list and/or an error code priority value for each error code in the error code list.

At operation 230, in the example, the model training device 202 performs feature selection on the training validations 212. Feature selection includes building a training dataset 234 to be used during model training 240 by restricting the fields present in the training validations 212 prior to training. More specifically, the model training device 202 builds the training dataset 234 to include all of the validations present in the training validations 212, but only includes the fields identified by the training features 232. As such, the training features 232 are a list of fields that are included in the training dataset 234, where other fields are removed for the model training 240.

In examples, the training features 232 include the validation status and the failed rules list, as well as one or more elements of transaction data (e.g., fields that are most pertinent to the failing of particular rules and the generation of particular errors). In some examples, the elements of transaction data used in the training features 232 include one or more of: processing code, cardholder transaction type, cardholder from account type, cardholder to account type, merchant type, POS PAN entry mode, POS PIN entry capability, card acceptor terminal identification, card acceptor identification code, currency code, additional amounts, account type, amount type, currency code, debit or credit indicator, POS terminal attendance, POS terminal location, POS cardholder presence, POS card presence, POS card capture capabilities, POS transaction status, POS transaction security, cardholder-activated terminal level/terminal type, POS card data terminal input capability indicator, POS authorization life cycle, POS country code, and POS postal code.

As such, the training validations 212 are effectively pruned down to include just the training features 232, thereby resulting in the training dataset 234. At operation 240, in the example, the model training device 202 performs model training to train the specific model 146A using this training dataset 234. As described herein the rules model 146A is trained on a set of historical validations (e.g., training validations 212) that include the training features 232, each of which are effectively labeled as successful or failed validations (e.g., as defined by the validation status), and where each failed validation is labeled with one or more validation rules 128 that triggered that validation failure. As such, the rules model 146A is configured to take, as inputs, a plurality of transactions (each of which includes the identified training features 232), and to generate, as outputs, a list of one or more validation rules 128.

In some examples, the model training of operation 240 includes applying Association Rule Mining (ARM) (e.g., Apriori Algorithm) to build the rules model 146A. For example, for the following code:

Code Snippet #1 - Association Rule Mining

```
from mlxtend.frequent_patterns import apirori, association_rules
import pandas as pd
# Sample payment transaction data
data = {‘transaction_id’: [1, 2, 3, 4, 5],
  ‘customer_id’: [101, 102, 103, 101, 104],
  ‘amount’: [250, 150, 300, 200, 100],
  ‘failure reason’: [‘5’, ‘10’],
  ‘Edit’: [‘DE5sf1’, ‘DE10’],
  ‘payment_method’: [‘POS’, ‘CHIP’, ‘ECOM’, ‘TAP’, ‘NFC’]}
df = pd.DataFrame(data)
# Convert the payment_method column to one-hot encoding
df_onehot = pd.get_dummies(df[‘payment_method’])
# Generate frequent itemsets
frequent_itemsets = apriori(df_onehot, min_support=0.6,
use_colnames=True)
# Generate association rules
rules = association_rules(frequent_itemsets, metric=“lift”,
min_threshold=1)
```

The example code is configured to identify frequent item sets in transactional data and derive association rules from them. More specifically, the Apriori algorithm works by identifying the most frequent combinations of items in a dataset and then generating rules that describe how the presence of certain items in a transaction implies the presence of other items.

More specifically, in this example, the model training device 202 first scans the dataset to identify individual items (e.g., 1-itemsets) that meet a minimum support threshold. The model training device 202 then iteratively combines these items to form larger itemsets (e.g., k-itemsets) and filters out those that do not meet the support threshold. In each iteration, the model training device 202 generates candidate itemsets of length k from the frequent itemsets of length k−1 and uses the Apriori property, which states that all non-empty subsets of a frequent itemset must also be frequent. This helps in pruning the candidate itemsets. The model training device 202 scans the dataset to count the occurrences of each candidate itemset. Itemsets that meet the minimum support threshold are considered frequent. From the frequent itemsets, the algorithm generates association rules that satisfy a minimum confidence threshold.

At operation 250, after the rules model 146A is trained, the model training device 202 performs model evaluation on the trained rules model 146A using the evaluation dataset 218. For example, the model training device 202 may apply the transactions included in the evaluation dataset 218 to the rules model 146A to output a particular subset of validation rules. The model training device 202 may then apply that subset of validation rules to the transactions of the evaluation dataset 218 to determine how many transactions are identified as failing (e.g., having one or more errors, based on this example primary validation with this subset of rules). To the extent that more of the actually-failed transactions in the evaluation dataset 218 are identified as failures during the primary validation, this indicates a more useful set of rules (e.g., a better performing rules model 146A). In other words, if the rules model 146A generates a rule subset that identifies most of the actually-failing transactions in the evaluation dataset 218 as failed under this rules subset, then the rules model 146A is well trained, where if the rule subset does not identify many of the actually-failing transactions as failed under this rules subset, then the rules model 146A is less-well trained.

Upon training the rules model 146A, and perhaps after successful model evaluation, the rules model 146A is stored in the models database 130, along with the environmental context 242 associated with that rules model 146A. As such, given a particular environmental context 242 with later transactions (e.g., the transactions 114 shown in FIG. 1), this particular rules model 146A can thus be identified from the models database 130.

FIG. 2B is a flow chart and data flow diagram 260 that illustrates details regarding model training for an example failure model 166A. In some examples, the model training shown in FIG. 2B is similar to the model training 161 of FIG. 1B. In the example, a device such as the validator device 120 or the model training device 202 trains the failure model 166A, as well as numerous other failure models 166. Such models 166 are stored in the models database 130, which in some examples is used during the failure analytics process described in FIG. 1B to select a particular model 166A given the particular failed transaction 170A and error code(s) 172A. It is presumed that each of these failure models 166, once trained, is thus configured to take a failed transaction 170A and one or more error codes 172A as input and generate an output that identifies one or more proposed corrections 174 for that failed transaction 170A.

More specifically, in examples, for a particular failure model 166A, the model training device 202 identifies a set of criteria filters 220 to be used for this specific failure model 166A. The criteria filters 220 can include, for example, one or more of a particular customer ID 222 (e.g., identifying the submitting institution 111), a particular region ID 224 (e.g., identifying a particular geographic region, jurisdiction, country, or the like), a transaction type 226 (shown here as “auth/clearing”, such as authorization-type transactions or clearing-type transactions), a date range 228, and one or more error codes 229 (e.g., similar to error codes 172). Criteria filters 220 can include any combination of these filters, as well as perhaps multiple filters of each type (e.g., multiple customer IDs 222, multiple regions 224, multiple transaction types 226, multiple date ranges 228, multiple error codes 229).

Criteria filters 220, in the example, represent filters that are used to identify which particular historical failed validations 162 (e.g., historical transactions that failed during a historical validation process) are used to train a specific model 166A. More specifically, at operation 262, the model training device 202 selects historical failed validations to be used for training this particular model 166A based on the criteria filters 220 identified for this model 166A (e.g., as selection criteria from historical failed validations 162). Some such data may be referred to herein as “environmental context,” such as merchant ID, acquirer ID, issuer ID, terminal ID, cardholder number, region, and/or error code(s), inasmuch as such data may be used as some criteria filters 220 during model training, as well as environmental context 242 associated with a particular rules model 166A that may be present with failed transactions 170 and used during model selection 168 (e.g., to identify the specific failure model 166A to use for that particular failed transaction 170A).

Each of the historical failed validations 162, in the example, includes transactions having similar attributes to transactions 114, and that were previously evaluated using the set of validation rules 128, as well as validation data that indicates the error code(s) identified during that failed validation. More specifically, in examples, each historical failed validation 162 includes (1) transaction data associated with a particular transaction (e.g., fields of data associated with the transaction, such as merchant type, account type, currency code, date/time of the transaction, and many others), as well as (2) validation failure data associated with the historical failed validation of that transaction (e.g., one or more error codes generated during validation). In some examples, the historical failed validations 142 include data collected during validations of transactions 114 actually performed by the validator device 120 (e.g., during the validation process shown and described in FIG. 1A). In some examples, the historical failed validations 162 include data generated by the model training device 202 after applying all of the validation rules 128 to one or more transactions (e.g., historical transactions performed on the payment network 102, test transactions, or the like). Accordingly, for each historical failed validation 162, numerous transaction fields are included for a particular transaction (e.g., as identified by the transaction data), as well as the validation failure data associated with that validation failure (e.g., as identified by the validation failure data).

Further, in the example shown in FIG. 2B, the model training device 202 also uses a database of successful resubmissions 261 during model training. Each successful resubmission 261 represents a transaction that had previously been submitted and, for some reason, failed validation during the validation process, but was resubmitted and successfully passed the validation process (e.g., after presumably some changes were made to correct the underlying transaction). Historical failed transactions 162 are paired with their associated historical successful resubmissions 261 to facilitate the determination of changes made between a failed validation and a successful validation under the same transaction. These transaction pairings are described in greater detail below.

As such, during the example operation 262, the model training device 202 identifies a plurality of historical failed validations 162 that match the criteria filter(s) 220. Further, the model training device 202 also retrieves historical successful resubmissions 261 that match each of the selected historical failed validations 162 (e.g., selected by transaction ID of the historical failed validation, or the like). Accordingly, to train the rules model 166A, the model training device 202 allocates a portion of the selected historical failed validations for training the model 166A (shown here as failed validations 264) and the remainder of the selected historical failed validations for use as an evaluation dataset 268 (e.g., to evaluate the performance of the model 166A after training). For example, the model training device 202 may select a percentage of the selected failed validations as failed validations 264 (e.g., 60%, 80%, or the like) and the remainder as evaluation dataset 268. Further, each failed validation 264 is paired with a successful resubmission 266, thus becoming a failed validation pair 263 (e.g., each with matching transaction ID). Likewise for the evaluation dataset 268, while not separately depicted within the evaluation dataset 268, the evaluation dataset 268 is also presumed to have failed validation pairs (e.g., where each failed validation is paired with a successful resubmission).

In examples, the transaction data for each failed validation 264 and successful resubmission 266 includes fields of data elements associated with the underlying transaction, such as, for example, cardholder information (e.g., primary account number (PAN) or payment token, cardholder name, card expiry date, card verification value (CVV/CVC), cardholder address, phone number, email), transaction details (e.g., transaction date/time, transaction amount, currency code, transaction type, transaction ID, authorization code, response code, approval code, retrieval reference number (RRN), settlement date, transaction status), merchant information (e.g., merchant name, merchant ID (MID), merchant category code (MCC), merchant location, merchant country code, acquirer bank name, acquirer bank identification number (BIN)), terminal and processing information (e.g., point of sale (POS) entry mode, terminal ID (TID), POS condition code, card present indicator, cardholder authentication method, electronic commerce indicator (ECI), tokenization indicator, fraud score), settlement and interchange information (e.g., interchange fee, processing fee, clearing reference number, batch number, chargeback indicator, reversal indicator), enhanced processing data (e.g., invoice number, customer reference ID, loyalty program data, cryptographic signature, tokenized payment data, and level 2/3 data fields such as tax amount, itemized line items, shipping amount, discount amount), or the like.

In examples, the validation failure data includes an error code list (e.g., for failed validations, one or more error codes identified by the failed validation rules), and may include one or more of a rule priority value for each rule in the failed rules list and/or an error code priority value for each error code in the error code list. In some examples, the validation failure data includes one or more proposed corrections 174 that were sent in response to the historical failed validation (e.g., at the time of the validation failure).

At operation 270, in the example, the model training device 202 performs feature selection on the failed validation pairs 263. Feature selection includes building a training dataset 274 to be used during model training 280 by restricting the fields present in the failed validation pairs 263 prior to training. More specifically, the model training device 202 builds the training dataset 274 to include all of the failed validation pairs 263, but only includes the fields identified by the training features 272. As such, the training features 272 are a list of fields that are included in the training dataset 274, where other fields are removed for the model training 280.

In examples, the training features 272 include the validation failure data (e.g., error codes), as well as one or more elements of transaction data (e.g., fields that are most pertinent to the historical validation failures and their associated successful resubmissions). In some examples, the elements of transaction data used in the training features 272 include one or more of: processing code, cardholder transaction type, cardholder from account type, cardholder to account type, merchant type, POS PAN entry mode, POS PIN entry capability, card acceptor terminal identification, card acceptor identification code, currency code, additional amounts, account type, amount type, currency code, debit or credit indicator, POS terminal attendance, POS terminal location, POS cardholder presence, POS card presence, POS card capture capabilities, POS transaction status, POS transaction security, cardholder-activated terminal level/terminal type, POS card data terminal input capability indicator, POS authorization life cycle, POS country code, and POS postal code.

As such, the failed validation pairs 263 are effectively pruned down to include just the training features 272, thereby resulting in the training dataset 274. At operation 250, in the example, the model training device 202 performs model training to train the specific model 166A using this training dataset 274. In this example, the failure model 166A is trained on a set of historical failed validations (e.g., failed validations 264) and their associated successful resubmissions (e.g., successful resubmissions 266), as well as the error code(s) generated during the historical validation failure. As such, the failure model 166A is configured to take, as inputs, a failed validation (e.g., transaction data associated with a transaction that has failed validation) and one or more error codes (e.g., the error codes identified during that failed validation), and to generate, as outputs, one or more proposed corrections 174.

In some examples, the model training of operation 280 includes training the failure model 166A using the training dataset 274 (e.g., similar to model training 240 of FIG. 2A). Once trained, this failure model 166A may be associated with a particular environmental context 242 (e.g., similar to rules model 146A). At operation 282, after the failure model 166A is trained, the model training device 202 performs model evaluation on the trained failure model 166A using the evaluation dataset 268 (e.g., similar to model evaluation 250 of FIG. 2A).

Upon training the failure model 166A, and after successful model evaluation, the failure model 166A is stored in the models database 130, along with the environmental context 242 associated with that failure model 166A. As such, given a particular environmental context 262 with later transactions (e.g., the transactions 114 shown in FIG. 1), this particular failure model 166A can thus be identified from the models database 130.

FIG. 3 is a flow chart and data flow diagram 300 for an example validation process. In some examples, the validation process shown in FIG. 3 is performed by the validation system 100 shown in FIG. 1. In the example, the validator device 120 receives transactions 114 at operation 310. At operation 312, the validator device 120 identifies environmental context 242 associated with those transactions (e.g., customer ID, region, or the like), and uses that environmental context 242 to identify the particular rules model 146A from the models database 130. At operation 314, the validator device 120 determines a validation type (e.g., between a primary validation, a secondary validation, or a full validation). In this example, it is presumed that the validator device 120 beings processing validation of these transactions 114 with a primary validation phase, starting at primary validation 104.

During the primary validation phase, the validator device 120 generates the primary subset 124 of validation rules 128 at operation 320. More specifically, in examples, the validator device 120 inputs the transactions 114 (or particular fields of the transactions 114, based on the training features 232 used for the rules model 146A) to the rules model 146A, thereby causing the rules model 146A to generate the primary subset 124. As described above, the primary subset 124 includes a subset of rules from the validation rules 128. At operation 322, the validator device 120 applies each of the rules in the primary subset 124 to each of the transactions 114. This primary validation thus identifies each transaction as either error-free (at this stage, an interim determination) or having one or more errors (e.g., based only on application of this primary subset 124). The transactions that have succeeded during this phase are the “primary-clean transactions 304”, where the transactions that have failed during this phase are the “primary-failing transactions 302.” Accordingly, at operation 324, the validator device 120 identifies the primary-failing transactions 302 and generates a primary failing response 122A for those primary-failing transactions 302 at operation 326, transmitting this response 122A back to the submitter (e.g., the banking device 110). This primary failing response 122A identifies each primary-failing transaction and includes error information such as an error code, an error description, or the like.

At the end of the primary validation stage, at operation 328, the validation device 120 identifies the primary-clean transactions 304 (e.g., all those transactions that did not generate an error during primary validation 104) and proceeds to a secondary validation phase and the secondary validation 106.

During the secondary validation phase, the validator device 120 identifies the remaining rules 126 at operation 330. The remaining rules 126 are all of the rules in the full list of validation rules 128 that were not applied during the primary validation phase (e.g., all of the validation rules 128 excluding each of the rules in the primary subset). At operation 332, the validator device 120 applies each of the remaining rules to each of the primary-clean transactions 304. As such, this secondary validation 106 identifies each primary-clean transaction 304 as either error-free or having one or more errors. The transactions that have succeeded during this phase are “secondary-clean transactions 308”, whereas the transactions that have failed during this phase are the “secondary-failing transactions 306.” At operation 334, the validator device 120 identifies the secondary-failing transactions 306 and generates a secondary failing response 122B for those secondary-failing transactions 306 at operation 336, transmitting this response 122B back to the submitter (e.g., the banking device 110). This secondary failing response 122B identifies each secondary-failing transaction and includes error information such as an error code, an error description, or the like.

At operation 338, in the example, the validator device 120 processes the secondary-clean transactions 308 (e.g., forwarding authorization-type transactions on for authorization, forwarding clearing-type transactions on for clearing, and the like). At operation 340, in some examples, the validator device 120 generates and transmits a clean response 122C back to the banking device 110, thereby identifying the final processing status of those secondary-clean transactions 308.

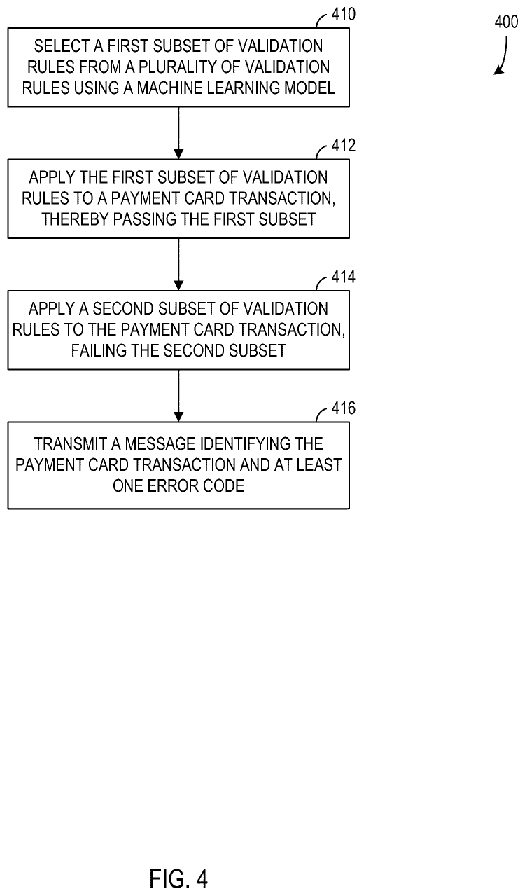

FIG. 4 is a flow chart of a method 400 of validating payment card transactions. In examples, the method 400 is performed by one or more of the validator device 120 shown in FIG. 1A and the model training device 202 shown in FIG. 2A. In the example, at operation 410, the validator device 120 uses a machine learning model (e.g., rules model 146A) to select a first subset of validation rules (e.g., primary subset 124) from a plurality of validation rules (e.g., validation rules 128). At operation 412, the validator device 120 applies the first subset of validation rules to a first payment card transaction (e.g., transactions 114), thereby identifying the first payment card transaction as passing the first subset of validation rules (e.g., during primary validation 104). At operation 414, the validator device 120 applies a second subset of validation rules (e.g., remaining rules 126) to the first payment card transaction, thereby identifying the first payment card transaction as failing the second subset of validation rules (e.g., during secondary validation 106), the failure of the second subset of validation rules identifying at least one error code. At operation 416, the validator device 120 transmits a message (e.g., response 122, secondary failing response 122B) to a computing device (e.g., banking device 110), the message identifying the first payment card transaction and the at least one error code.

In some examples, the validator device 120 or the model training device 202 is configured to train the machine learning model using a plurality of historical validations of historical payment card transactions (e.g., historical transactions 142), each historical validation of the plurality of historical validations includes a validation status and a plurality of transaction details. In some examples, the machine learning model is configured to take, as input, transaction data associated with one or more payment card transactions, and to output one or more validation rules of the plurality of validation rules. In some examples, the validator device 120 or the model training device 202 is further configured to identify a filter criterion (e.g., criteria filters 220) and select the plurality of historical validations from a database of historical validations based on the filter criterion, the plurality of historical validations being a training dataset (e.g., training validations 212, training dataset 234) used for the training of the machine learning model. In some examples, the validator device 120 is further configured to identify an element of environmental context associated with the first payment card transaction (e.g., environmental context 242) and select the machine learning model from a plurality of machine learning models (e.g. models database 130) based on the environmental context of the first payment card transaction matching the filter criterion used during the selecting of the plurality of historical validations.

In some examples, the validator device 120 is further configured to apply the first subset of validation rules to a second payment card transaction, thereby identifying the second payment card transaction as failing the first subset of validation rules.

### Exemplary Operating Environment

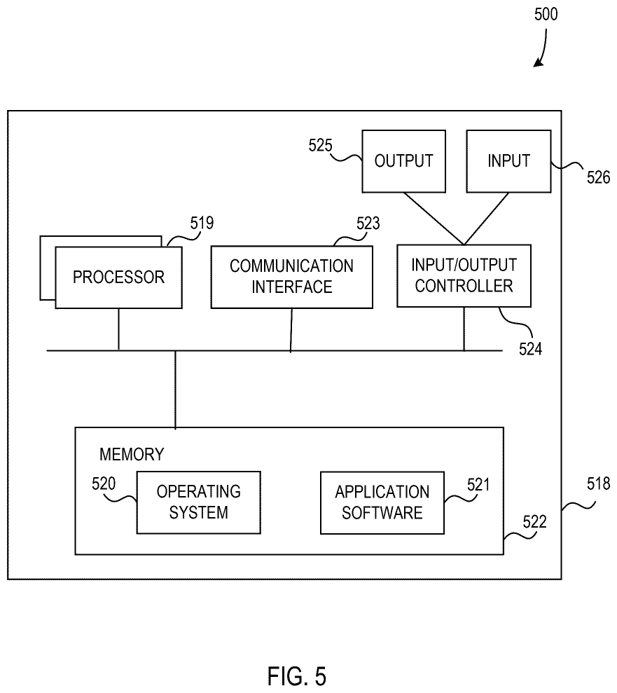

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 is a computing device, such as, but not limited to, the validator device 120, the model training device 202, and the banking device 110 in FIG. 1.

The computing apparatus 518 comprises one or more processors 519 which can be microprocessors, controllers, or any other suitable type of processors for processing computer executable instructions to control the operation of the electronic device. Alternatively, or in addition, the processor 519 is any technology capable of executing logic or instructions, such as a hardcoded machine. In some examples, platform software comprising an operating system 520 or any other suitable platform software is provided on the apparatus 518 to enable application software 521 to be executed on the device.

In some examples, computer executable instructions are provided using any computer-readable medium or media accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals per se are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 in other examples outputs data to devices other than the output device, e.g., a locally connected printing device. In some examples, a user provides input to the input device(s) 526 and/or receives output from the output device(s) 525.

The functionality described herein can be performed, at least in part, by one or more hardware logic components. The computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### ADDITIONAL EXAMPLES

In some examples, a validation system is provided. The validation system includes at least one processor; and at least one memory comprising computer-readable instructions, the at least one processor, the at least one memory and the computer-readable instructions configured to cause the at least one processor to: receive a first payment card transaction from a submitter device; automatically select a first subset of validation rules from a plurality of validation rules using a machine learning model, the machine learning model being configured to identify the first subset of validation rules; apply the first subset of validation rules to the first payment card transaction, thereby identifying the first payment card transaction as passing the first subset of validation rules without indicating an error with the first payment card transaction; after identifying that the first payment card transaction passes the subset of validation rules, apply a second subset of validation rules to the first payment card transaction, thereby identifying the first payment card transaction as failing the second subset of validation rules, the failure of the second subset of validation rules identifying at least one error code; and transmit a message to the submitter device, the message identifying the first payment card transaction and the at least one error code.

In some examples, a computer-implemented method of validating payment card transactions is provided. The method includes: using a machine learning model to select a first subset of validation rules from a plurality of validation rules; applying the first subset of validation rules to a first payment card transaction, thereby identifying the first payment card transaction as passing the first subset of validation rules; applying a second subset of validation rules to the first payment card transaction, thereby identifying the first payment card transaction as failing the second subset of validation rules, the failure of the second subset of validation rules identifying at least one error code; and transmitting a message to a computing device, the message identifying the first payment card transaction and the at least one error code.

In some examples, a computer storage medium having computer-executable instructions is provided. Upon execution by a processor of a computer, the computer-executable instructions cause the processor to at least: receive a first payment card transaction from a submitter device; automatically select a first subset of validation rules from a plurality of validation rules using a machine learning model, the machine learning model being configured to identify the first subset of validation rules; apply the first subset of validation rules to the first payment card transaction, thereby identifying the first payment card transaction as passing the first subset of validation rules without indicating an error with the first payment card transaction; after identifying that the first payment card transaction passes the subset of validation rules, apply a second subset of validation rules to the first payment card transaction, thereby identifying the first payment card transaction as failing the second subset of validation rules, the failure of the second subset of validation rules identifying at least one error code; and send a response message to the submitter device, the response message including a transaction identifier of the first payment card transaction and an error code identifier of the at least one error code.

In some examples, a validation system is provided. The validation system includes: at least one processor; and at least one memory comprising computer-readable instructions, the at least one processor, the at least one memory and the computer-readable instructions configured to cause the at least one processor to: receive a first payment card transaction from a submitter device; automatically select a first subset of validation rules from a plurality of validation rules using a machine learning model, the machine learning model being configured to identify the first subset of validation rules; apply the first subset of validation rules to the first payment card transaction, thereby identifying the first payment card transaction as failing the first subset of validation rules, the failure of the first subset of validation rules identifying at least one error code; and transmit a message to the submitter device, the message identifying the first payment card transaction and the at least one error code.

In some examples, a computer-implemented method of validating payment card transactions is provided. The method includes: using a machine learning model to select a first subset of validation rules from a plurality of validation rules; applying the first subset of validation rules to a first payment card transaction, thereby identifying the first payment card transaction as failing the first subset of validation rules, the failure of the first subset of validation rules identifying at least one error code; and transmitting a message to a computing device, the message identifying the first payment card transaction and the at least one error code.

In some examples, a computer storage medium having computer-executable instructions is provided. Upon execution by a processor of a computer, the computer-executable instructions cause the processor to at least: receive a first payment card transaction from a submitter device; automatically select a first subset of validation rules from a plurality of validation rules using a machine learning model, the machine learning model being configured to identify the first subset of validation rules; apply the first subset of validation rules to the first payment card transaction, thereby identifying the first payment card transaction as failing the first subset of validation rules, the failure of the first subset of validation rules identifying at least one error code; and transmit a message to the submitter device, the message identifying the first payment card transaction and the at least one error code.

Alternatively, or in addition to the other examples described herein, examples include any combination of the following:
receive a first payment card transaction from a submitter device;
automatically select a first subset of validation rules from a plurality of validation rules using a machine learning model;
a machine learning model being configured to identify the first subset of validation rules;
apply the first subset of validation rules to the first payment card transaction;
identifying the first payment card transaction as passing the first subset of validation rules without indicating an error with the first payment card transaction;
after identifying that the first payment card transaction passes the subset of validation rules, apply a second subset of validation rules to the first payment card transaction;
identifying the first payment card transaction as failing the second subset of validation rules;
the failure of the second subset of validation rules identifying at least one error code;
transmit a message to the submitter device, the message identifying the first payment card transaction and the at least one error code;
train the machine learning model using a plurality of historical validations of historical payment card transactions;
each historical validation of the plurality of historical validations includes a validation status and a plurality of transaction details;
the machine learning model is configured to take, as input, transaction data associated with one or more payment card transactions;
the machine learning model is configured to output one or more validation rules of the plurality of validation rules;
identify a filter criterion;
select the plurality of historical validations from a database of historical validations based on the filter criterion;
the plurality of historical validations being a training dataset used for the training of the machine learning model;
identify an element of environmental context associated with the first payment card transaction;
select the machine learning model from a plurality of machine learning models based on the environmental context of the first payment card transaction matching the filter criterion used during the selecting of the plurality of historical validations;
receive a second payment card transaction from the submitter device;
apply the first subset of validation rules to the second payment card transaction, thereby identifying the second payment card transaction as failing the first subset of validation rules;
automatically identifying a proposed correction for the failing of the first subset of validation rules by the first payment card transaction using another machine learning model, the other machine learning model being configured to identify the proposed correction; and
transmitting the proposed correction to the computing device.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for using a machine learning model to select a first subset of validation rules from a plurality of validation rules; exemplary means for applying the first subset of validation rules to a first payment card transaction, thereby identifying the first payment card transaction as passing the first subset of validation rules; exemplary means for applying a second subset of validation rules to the first payment card transaction, thereby identifying the first payment card transaction as failing the second subset of validation rules, the failure of the second subset of validation rules identifying at least one error code; and exemplary means for transmitting a message to a computing device, the message identifying the first payment card transaction and the at least one error code.

At least a portion of the functionality of the various elements in FIG. 1A to FIG. 5 can be performed by other elements in FIG. 1A to FIG. 5, or an entity (e.g., processor, web service, server, application program, computing device, etc.) not shown in FIG. 1A to FIG. 5.

In some examples, the operations illustrated in FIG. 1A to FIG. 5 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium has instructions recorded thereon which when executed by a computer device cause the computer device to cooperate in performing a method for validating payment card transactions; using a machine learning model to select a first subset of validation rules from a plurality of validation rules; applying the first subset of validation rules to a first payment card transaction, thereby identifying the first payment card transaction as passing the first subset of validation rules; applying a second subset of validation rules to the first payment card transaction, thereby identifying the first payment card transaction as failing the second subset of validation rules, the failure of the second subset of validation rules identifying at least one error code; and transmitting a message to a computing device, the message identifying the first payment card transaction and the at least one error code.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A validation system comprising:
at least one processor;
at least one memory comprising computer-readable instructions;
a models database communicatively coupled to the at least one memory or the at least one processor, the models database storing a plurality of machine learning (ML) models;
the at least one memory storing the computer-readable instructions that, when executed by the at least one processor, cause the at least one processor to:
receive a first payment card transaction from a submitter device associated with a submitter;
based on the first payment card transaction, select an ML model from the plurality of ML models, the selected ML model having been trained by the validation system, the training comprising:
tailoring the selected ML model to a plurality of transaction criteria specific to the submitter, the plurality of transaction criteria comprising at least one of a customer, a region, or a transaction type,
identifying a plurality of historical validations specific to the submitter, the plurality of historical validations of a plurality of historical payment card transactions comprising a historical validation matching a transaction criterion of the plurality of transaction criteria,
using the historical validation, training the ML model to take as a first input a plurality of transaction features associated with at least one transaction of a plurality of transactions and generate a plurality of validation rules, the plurality of validation rules being most likely to generate at least one error in the plurality of transactions;
use the selected ML model to:
select a first subset of validation rules from the plurality of validation rules associated with the selected ML model, the first subset of validation rules being only a portion of the plurality of validation rules, and being most likely to identify an error within the first payment card transaction;
apply the first subset of validation rules to the first payment card transaction;
based on applying the first subset of validation rules:
identify the first payment card transaction as failing the first subset of validation rules,
wherein the failure of the first subset of validation rules identifies at least one error code; and
transmit a message to the submitter device, the message identifying the first payment card transaction and the at least one error code.

2. The validation system of claim 1, wherein each historical validation of the plurality of historical validations comprises a validation status and a plurality of transaction details.

3. The validation system of claim 1, wherein the selected ML model is further configured to take, as a second input, transaction data associated with one or more payment card transactions, and to output at least one validation rule of the plurality of validation rules.

4. The validation system of claim 1, wherein the computer-readable instructions are further configured to cause the at least one processor to:
identify a filter criterion; and
select the plurality of historical validations from a database of historical validations based on the filter criterion, the plurality of historical validations being a training dataset used for the training of the ML model.

5. The validation system of claim 4, wherein the computer-readable instructions are further configured to cause the at least one processor to:
identify an element of an environmental context associated with the first payment card transaction; and
select the ML model based at least in part on the environmental context of the first payment card transaction matching the filter criterion used during the selecting of the plurality of historical validations.

6. The validation system of claim 1, wherein the computer-readable instructions are further configured to cause the at least one processor to:
receive a second payment card transaction from the submitter device; and
apply the first subset of validation rules to the second payment card transaction, thereby identifying the second payment card transaction as passing the first subset of validation rules without indicating an error with the second payment card transaction; and
after identifying that the second payment card transaction passes the first subset of validation rules, apply a second subset of validation rules to the second payment card transaction, thereby identifying the second payment card transaction as failing the second subset of validation rules, the failure of the second subset of validation rules identifying another error code.

7. The validation system of claim 1, wherein the computer-readable instructions are further configured to cause the at least one processor to:
automatically identify a proposed correction for the failing of the first subset of validation rules by the first payment card transaction using a second machine learning (ML) model from the models database, the second ML model being configured to identify the proposed correction; and
include, in the transmitted message, the proposed correction.

8. A computer-implemented method of validating payment card transactions, the method comprising:
based on a first payment card transaction associated with a submitter, selecting a machine learning (ML) model from a plurality of ML models stored in a models database, the selected ML model having been trained, the training comprising:
tailoring the selected ML model to a plurality of transaction criteria specific to the submitter, the plurality of transaction criteria comprising at least one of a customer, a region, or a transaction type,
identifying a plurality of historical validations specific to the submitter, the plurality of historical validations comprising a historical validation matching a transaction criterion of the plurality of transaction criteria,
using the historical validation, training the ML model to take as a first input a plurality of transaction features associated with at least one transaction of a plurality of transactions and generate a plurality of validation rules, the plurality of validation rules being most likely to generate at least one error in the plurality of transactions;
using the selected ML model to select a first subset of validation rules from the plurality of validation rules associated with the selected ML model, the first subset of validation rules being only a portion of the plurality of validation rules, and being most likely to identify an error within the first payment card transaction;
applying the first subset of validation rules to the first payment card transaction;
based on applying the first subset of validation rules, identifying the first payment card transaction as failing the first subset of validation rules, the failure of the first subset of validation rules identifying at least one error code; and
transmitting a message to a computing device, the message identifying the first payment card transaction and the at least one error code.

9. The method of claim 8, wherein a historical validation of the plurality of historical validations comprises a validation status and a plurality of transaction details.

10. The method of claim 8, wherein the selected ML model is further configured to take, as a second input, transaction data associated with one or more payment card transactions, and to output at least one validation rule of the plurality of validation rules.

11. The method of claim 8, further comprising:
identifying a filter criterion; and
selecting the plurality of historical validations from a database of historical validations based on the filter criterion, the plurality of historical validations being a training dataset used for the training of the ML model.

12. The method of claim 11, further comprising:
identifying an element of an environmental context associated with the first payment card transaction; and
selecting the ML model based at least in part on the environmental context of the first payment card transaction matching the filter criterion used during the selecting of the plurality of historical validations.

13. The method of claim 8, further comprising:
receiving a second payment card transaction;
applying the first subset of validation rules to the second payment card transaction, thereby identifying the second payment card transaction as passing the first subset of validation rules without indicating an error with the second payment card transaction; and
after identifying that the second payment card transaction passes the first subset of validation rules, applying a second subset of validation rules to the second payment card transaction, thereby identifying the second payment card transaction as failing the second subset of validation rules, the failure of the second subset of validation rules identifying another error code.

14. The method of claim 8, further comprising:
automatically identifying a proposed correction for the failing of the first subset of validation rules by the first payment card transaction using a second machine learning (ML) model, the second ML model being configured to identify the proposed correction; and
transmitting the proposed correction to the computing device.

15-20. (canceled)

21. A non-transitory computer storage medium having computer-executable instructions that, upon execution by a processor of a computer, cause the processor to at least:
based on a first payment card transaction associated with a submitter, select a machine learning (ML) model from a plurality of ML models stored in a models database, the selected ML model having been trained, the training comprising:
tailoring the selected ML model to a plurality of transaction criteria specific to the submitter, the plurality of transaction criteria comprising at least one of a customer, a region, or a transaction type,
identifying a plurality of historical validations specific to the submitter, the plurality of historical validations comprising a historical validation matching a transaction criterion of the plurality of transaction criteria,
using the historical validation, training the ML model to take as a first input a plurality of transaction features associated with at least one transaction of a plurality of transactions and generate a plurality of validation rules, the plurality of validation rules being most likely to identify at least one error in the plurality of transactions;
using the selected ML model, select a first subset of validation rules from the plurality of validation rules associated with the selected ML model, the first subset of validation rules being only a portion of the plurality of validation rules, and being most likely to identify an error within the first payment card transaction;
apply the first subset of validation rules to the first payment card transaction;
based on applying the first subset of validation rules, identify the first payment card transaction as failing the first subset of validation rules, the failing of the first subset of validation rules identifying at least one error code; and
transmit a message to a computing device, the message identifying the first payment card transaction and the at least one error code.

22. The non-transitory computer storage medium of claim 21, wherein a historical validation of the plurality of historical validations includes a validation status and a plurality of transaction details.

23. The non-transitory computer storage medium of claim 21, wherein the ML model is further configured to take, as a second input, transaction data associated with one or more payment card transactions, and to output at least one validation rule of the plurality of validation rules.

24. The non-transitory computer storage medium of claim 21, wherein the computer-executable instructions are further configured to cause the processor to:
identify a filter criterion; and
select the plurality of historical validations from a database of historical validations based on the filter criterion, the plurality of historical validations being a training dataset used for the training of the ML model.

25. The non-transitory computer storage medium of claim 24, wherein the computer-executable instructions are further configured to cause the processor to:
identify an element of an environmental context associated with the first payment card transaction; and
select the selected ML model from the plurality of ML models based at least in part on the environmental context of the first payment card transaction matching the filter criterion used during the selecting of the plurality of historical validations.

26. The non-transitory computer storage medium of claim 21, wherein the computer-executable instructions are further configured to cause the processor to:
automatically identify a proposed correction for the failing of the first subset of validation rules by the first payment card transaction using a second machine learning (ML) model, the second ML model being configured to identify the proposed correction; and
transmit the proposed correction to the computing device.
